(19) United States
(12) Patent Application Publication
(10) Pub. No.: US 2023/0265655 A1
(43) Pub. Date: Aug. 24, 2023

(54) Self-Locking Rebar Coupler

(71) Applicant: Shahn Christian Andersen, New York, NY (US)

(72) Inventor: Shahn Christian Andersen, New York, NY (US)

(21) Appl. No.: 17/679,081

(22) Filed: Feb. 24, 2022

(51) Int. Cl. E04C 5/16; F16B 7/18

(52) U.S. Cl. CPC E04C 5/165; F16B 7/182

(57) ABSTRACT

The present invention relates to a novel form of self-locking mechanical rebar coupler which is able to easily couple neighboring rebars by way of an inserting plug welded to one side of the rebar, which penetrates a receiving socket which is welded to another piece of rebar. It is then locked into place by a spring-loaded dowel which penetrates the inserting plug when the inserting plug pushes down a cap at the bottom of the receiving socket which had been holding the spring-loaded dowel in place. The purpose of this coupler is to transfer a load against tensile force and compression force in a stable manner by coupling two separate pieces of rebar and locking them into place. Various diameters of rebar can be used in this self-locking mechanical rebar coupler. The assembly by providing a self-locking rebar coupling, is aimed to reduce the size of rebar components which can be combined together on a construction site and improve construction speed.

### BACKGROUND

### Field of the Invention

The present invention relates generally to building construction, and particularly to provide improvements to mechanical rebar couplers by way of a Self-Locking Rebar Coupler.

### Description of the Related Art

According to Lambert and MacDonald in their 1998 monograph titled “Reinforced Concrete History, Properties & Durability” (published by the Corrosion Prevention Association, Surrey, U.K.), the oldest known surviving concrete is to be found in the former Yugoslavia and was thought to have been laid in 5,600 BC using red lime as the cement. The first major concrete users were the Egyptians in around 2,500 BC and the Romans from 300 BC. The Romans found that by mixing a pink sand-like material which they obtained from Pozzuoli with their normal lime-based concretes they, obtained a far stronger material. The pink sand turned out to be fine volcanic ash and they had inadvertently produced the first pozzolanic′ cement. Pozzolana is any siliceous or siliceous and aluminous material which possesses little or no cementitious value in itself but will, if finely divided and mixed with water, chemically react with calcium hydroxide to form compounds with cementitious properties.

The Romans made many developments in concrete technology including the use of lightweight aggregates as in the roof of the Pantheon, and embedded reinforcement in the form of bronze bars, although the difference in thermal expansion between the two materials produced problems of spoiling. It is from the Roman words ‘caementum’ meaning a rough stone or chipping and ‘concretus’ meaning grown together or compounded, that we have obtained the names for these two now common materials. Since the Romans had no powered cement mixers, they prepared small batches of concrete, and layered these hatches either between wooden forms, or between facings of stone or brick already assembled. The Roman practice of pouring liquid concrete into wooden forms was rediscovered by the architect Bramante in the 15th century A.D., and incorporated into his early work on the Cathedral of St. Peter in Rome.

The use of concrete forms continued to progress, with important developments including iron-reinforced structures in the 18th century and steel-reinforced concrete as a building material of the mid-19th century. Reinforced concrete is often used in the construction of foundation footings, which provide a base for the foundation of a structure. Footings are typically fabricated by placing opposed form elements, spaced 8″-48″ apart, around the design perimeter of the structure below the frostline. Form elements are usually elongate, and can be provided as removable wood or steel planks or permanently-installed foraminous drain elements. When planks are used, dimensional lumber, ranging from 1×4's and 2×4's through 1×12's and 2×12's, are often used for this purpose. The planks are usually secured together by a series of braces, such as 1×2's, to maintain the planks at a consistent distance from one another. Rebar or other reinforcing materials, such as mesh, can be secured within the form. Once the form is ready, concrete is poured to a desired depth and allowed to cure, after which the forms are removed.

Reinforced concrete is commonly used in the construction of tall buildings, bridges, roads, and other civil structures. It consists of steel rebar buried inside concrete and uses a significant amount of reinforcing bars. These reinforcing bars are sold in fixed lengths, and have to be connected together on site to create the steel cages necessary to reinforce concrete. In addition, when precast concrete construction units are manufactured and delivered to a construction site, it is necessary to connect the reinforcing bar of one precast member to another precast member. The most common ways to connect rebar include: overlapping reinforcing bars (lap splicing), press joints, welding, mechanical joining by couplers, and one-touch splicing.

The prior methods of connecting rebar each have drawbacks which make them slower and less efficient than this new invention. Overlapping reinforcing bars (lap splicing) to connect them requires a large amount of additional steel for the overlapping sections, the strength of the overlapping joint is weak, and it time consuming and labor-intensive to hand tie the overlapping areas together on the site. Press joint connections require a large crimping press that is difficult to maneuver on site. Welding rebar to make a connection is cumbersome to install on site and uses high heat to melt the weld, which can significantly weaken the strength of the reinforcing bar around the weld. Mechanical rebar couplers were invented as another means connect rebar, and use various types of mechanisms to connect rebar: threading rebar into them, using locking shear bolts, using grout inside couplings, all which are slow to install on the construction site

By looking at prior art multiple advancements have been seen in similar regards. For instance, U.S. Pat. No. 5,729,952A shows a method and apparatus for making and assembling reliable mechanical rebar couplers so that a short upstand of rebar that protrudes from an existing concrete structure can be connected to a new rebar at a retrofit work site out in the field so as to provide a connection between a new and the existing structure. According to a first embodiment, one end of the protruding upstand is upset, and a threaded male coupling member surrounds the protruding upstand behind the upset end thereof. The threaded male coupling member is mated to a threaded female coupling member that is affixed to the new rebar such that the upset end of the upstand is retained between the male and female coupling members. According to a second embodiment, one end of each of the protruding upstand and the new rebar is upset, and a threaded male coupling member surrounds the protruding upstand and the new rebar behind the respective upset ends thereof. The threaded male coupling members are then mated to opposite threaded ends of a hollow cylindrical female coupling member so that the upset ends of the protruding upstand and the new rebar are retained at the interior of the female coupling member.

JP patent JP2005518487A shows a mechanical connector for splicing together opposing ends of first and second steel reinforcing spaced apart from each other and positioned in axial alignment. The mechanical connector passes through the tube body and the hollow tube body receiving the opposing ends of the first and second reinforcing bars, and the first and second Removable stopper pins that are moved together between opposing ends of the reinforcing bars of the same to maintain an axial alignment therebetween, which are spliced together Core reinforcing means surrounding the opposing ends of the first and second reinforcing bars and the tube body are formed in the core reinforcing means and the first reinforcing rod. And the opposite ends of the second reinforcing bar are embedded and fixed And a solid core being a mechanical coupling.

US patent U.S. Pat. No. 11,028,588B2 discloses a rebar coupler. The rebar coupler includes a housing having first and second openings for receiving first and second rebars, respectively, and a partition disposed at a center; a mounting member inserted in each end of the housing and receiving rebars therein; a plurality of coupling members slidably disposed on the mounting member and being brought into contact with an outer peripheral surface of the inserted rebars to prevent the rebars from moving out from the rebar coupler; a resilient member configured to apply a restoring force to the coupling members so that the coupling members slid by the rebar inserted in the mounting member are returned to an original position; and a cover fastened to both ends of the housing to prevent the mounting member and the coupling members from moving out from the housing due to a tensile force of the rebar.

A KR patent 1,021,1602B1 relates to a mechanical rebar coupler which is able to easily couple neighboring rebars by inserting and coupling a fixing cap, which penetrates to be coupled to the other side of an expansion head of a second bar, into an accommodation space of an accommodation socket with a first bar coupled to one end thereof, to transfer a load against tensile force and compression force in a stable manner by coupling and making the rebars come in full contact with each other, and to freely couple rebars with various diameters. According to the present invention, the mechanical rebar coupler comprises: an accommodation socket: which has a first bar coupled to one end and an accommodation space formed on a front side so that an expansion head of a second bar, which is formed on the end part by expanding, is accommodated in the other end to come in full contact with and supported by a lower surface, and also has a male screw thread formed on an outer circumferential surface; a cylindrical fixing cap which has a female screw thread formed on an inner circumferential surface such that the other end of the accommodation socket: is coupled to the inside by screws, and a penetrating hole formed in the center to be penetrated by the second bar; and a pressurizer placed between the fixing cap and the expansion head to fix the expansion head in the accommodation socket by pressurizing of the fixing cap, and provided to have adjustable position controlled on the plane in the accommodation space.

It can thus be seen from the foregoing that several attempts have been made to provide structural reinforcements and to connect rebar. However clearly, the need exists for a simple, inexpensive and efficient mechanism which allows rebar to be installed faster on the construction site. The current assembly provides a reinforcing bar mechanical joint that is capable of easy, fast, strong installation and that can stably handle loads as well as tensile and compressive forces.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary objective of this invention is to provide improvements to mechanical rebar couplers by way of a Self-Locking Rebar Coupler.

It is a further object to eliminate the need for additional equipment for connecting reinforcing bars on the construction site as compared with the background art.

Still another important feature of this invention is in its simplicity of construction, ease of operation, effectiveness in use and its generally inexpensive manufacturing cost.

Another important object of the present invention is to provide technology which can reduce construction cost and can save time required for construction.

Another objective of the invention is to provide an assembly that allows to rapidly combine rebar by putting the inserting plug inside the receiving socket

Another objective of the invention is to provide a durable approach where the spring-loaded dowel locks the bars together, making it possible to construct the reinforcing bars without any additional equipment.

It is also the objective of invention to provide the tubular housing which can reduce the impact on the reinforced concrete connection even if there is an external impact while concrete is being poured onto the rebar for curing

it is further the objective of invention that with the presence of the protruding portion of the receiving pocket enables a visual inspection that the insertion has been properly consummated and the reinforcing bars are completely locked, so that the accuracy and safety of the reinforcing bar connection can be verified.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a cross-sectional view of the invention.

FIG. 2 shows the same parts as FIG. 1 in an isometric view.

FIG. 3 is conceptual view showing a first piece of rebar according to an embodiment of the present invention;

FIG. 4 shows the same parts as FIG. 3 in an isometric view;

FIG. 5 shows a side view of the pin inserted and locked according to another embodiment of the present invention;

FIG. 6 shows an isometric view of the pin inserted and locked;

FIG. 7 shows a cutaway view of the plug being inserted;

FIG. 8 shows a cutaway view of the plug after insertion with the pin dowel locked;

FIG. 9 shows a see-through view of the plug being inserted according to another embodiment of the present invention;

FIG. 10 shows a see-through view of the plug after insertion according to another embodiment of the present invention;

FIG. 11 is an angle view of the invention;

FIG. 12 is a different angle view of the unit;

FIG. 13 is a view for showing the length adjustment structure of the coupler body block according to the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention relates to an advancement in mechanical rebar couplings by means of a self-locking rebar coupling connection.

The present invention as per its preferred embodiments provide a reinforcing bar mechanical joint that is capable of easy, fast, strong installation that can stably handle loads as well as tensile and compressive forces. The present invention has the follow features for achieving the above object.

The present invention as per its additional embodiments eliminates the need for additional equipment for processing reinforcing bars during manufacturing and on the construction, site as compared with the background art, and can reduce construction cost and can save time required for construction.

The assembly as per its additional embodiments makes it possible to rapidly combine rebar by putting the inserting plug inside the receiving socket.

The assembly as per its additional embodiments, make it possible to construct the reinforcing bars without any additional equipment by the spring-loaded dowel locks the bars together.

The assembly as per its additional embodiments allows the tubular housing can reduce the impact on the reinforced concrete connection even if there is an external impact while concrete is being poured onto the rebar for curing.

The assembly as per its additional embodiments causes the presence of the protruding portion of the receiving pocket enables a visual inspection that the insertion has been properly consummated and the reinforcing bars are completely locked, so that the accuracy and safety of the reinforcing bar connection can be verified.

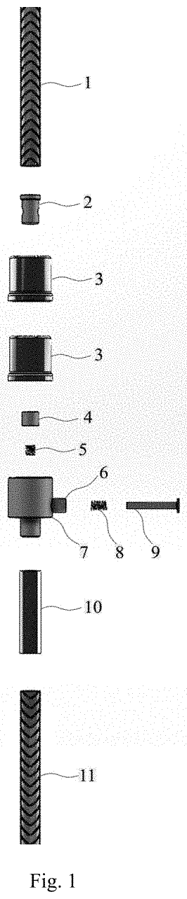

FIG. 1 is a view that shows all the components of the invention:

(1) first piece of rebar

(2) insertion plug

(3) two identical retaining clips

(4) cap for accordion spring

(5) accordion spring

(6) two identical retaining clips

(7) receiving socket

(8) locking pin spring

(9) locking pin dowel

(10) stability tube

(11) second piece of rebar

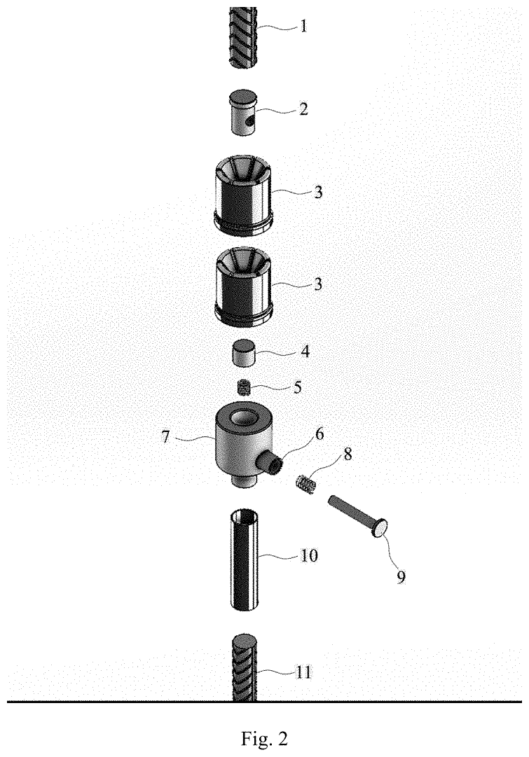

FIG. 2 shows the same parts as FIG. 1 in an isometric view.

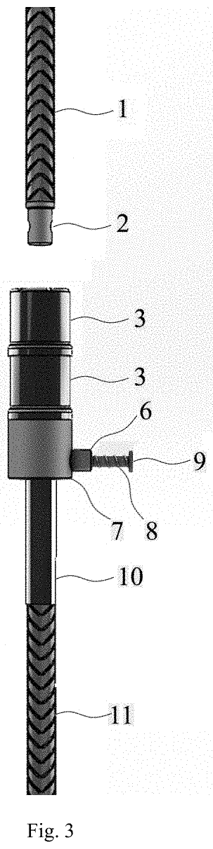

FIG. 3 is a view showing a first piece of rebar (1) welded to an insertion plug (2); and a second piece of rebar (11) welded to a receiving socket (7), and also welded to a stability tube (10) around that second piece of rebar, FIG. 3 also shows two identical retaining clips (3) welded together and welded onto a receiving socket (7). Locking pin spring (8) is wrapped around locking pin (9) and held back from insertion by the cap for accordion spring (4) which is held in place by the accordion spring (5). FIG. 3 shows the invention assembled and ready to be combined together on the construction site.

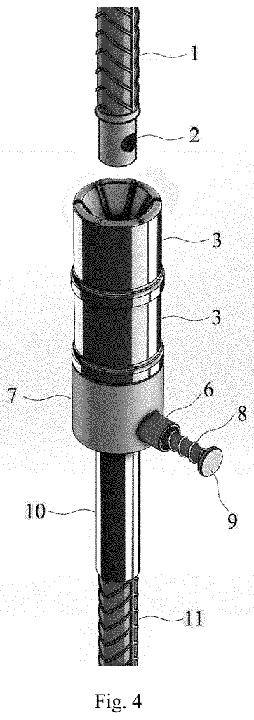

FIG. 4 shows the same parts as FIG. 3 in an isometric view.

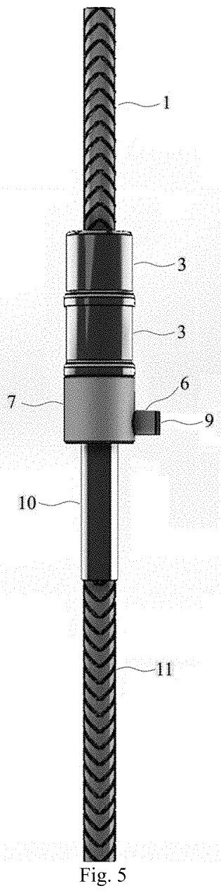

FIG. 5 shows a side view of the pin inserted and locked

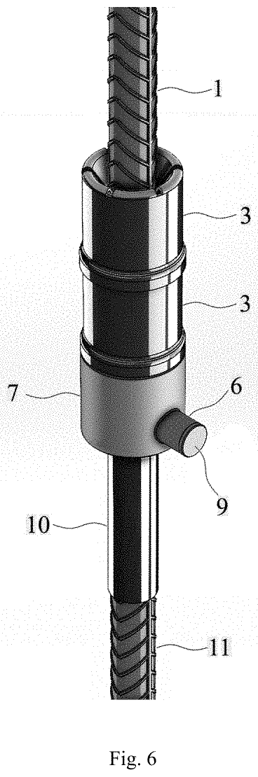

FIG. 6 shows an isometric view of the pin inserted and locked

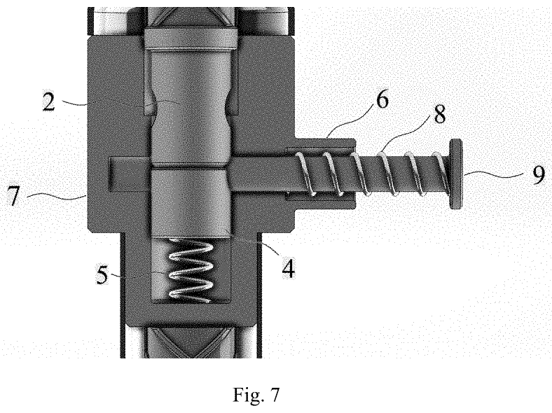

FIG. 7 shows a cutaway view of the plug being inserted

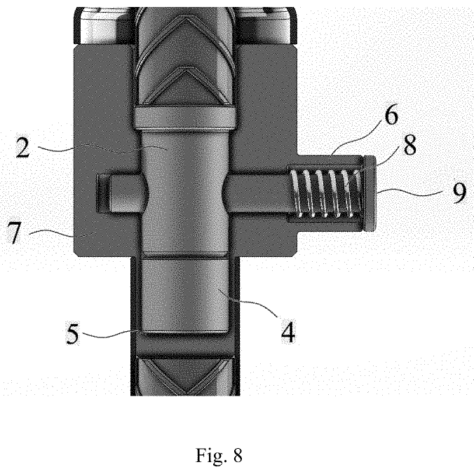

FIG. 8 shows a cutaway view of the plug after insertion with the pin dowel locked

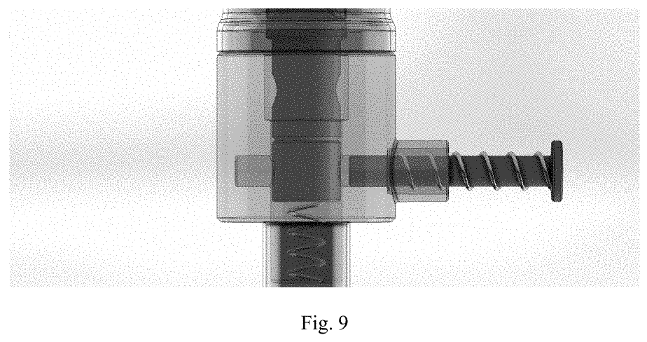

FIG. 9 shows a see-through view of the plug being inserted

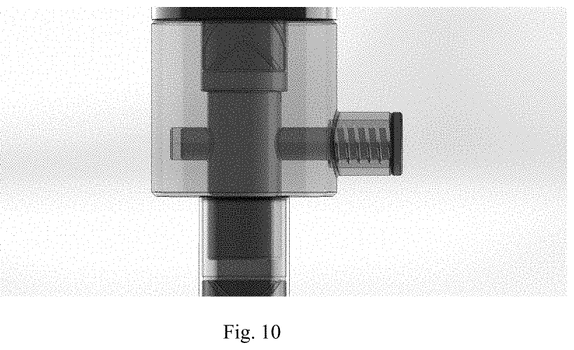

FIG. 10 shows a see-through view of the plug after insertion with the pin dowel locked

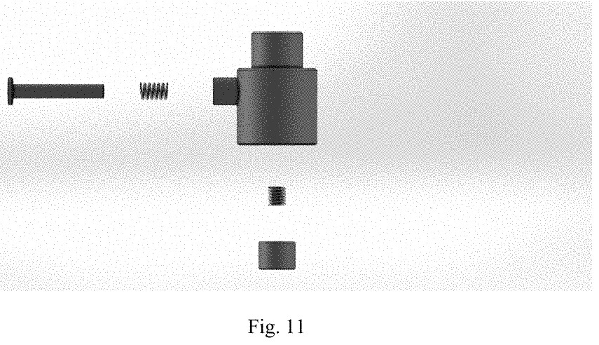

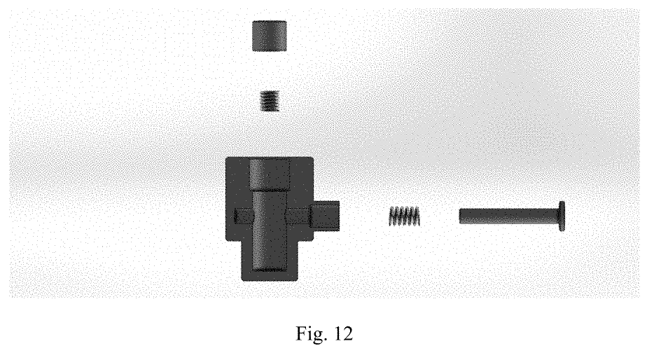

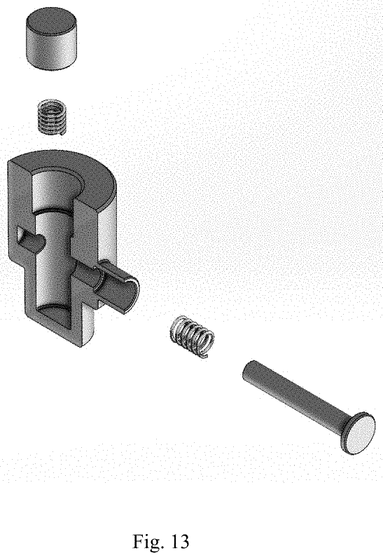

FIGS. 11, 12 and 13 show other angles of the unit.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A mechanical rebar coupler comprising:
a spring-resting cap to hold the dowel in place inside the receiving socket shaft;
circular retaining clips at the head of the receiving socket;
circular retaining clips to help guide the insertion plug; and,
the rebar welded onto into the proper location for penetration of the receiving socket.

2. A self-locking mechanical rebar coupler allowing to couple neighboring rebars:
as per claim 2, by way of an inserting plug welded to one side of the rebar;
as per claim 2, by inserting plug which penetrates a receiving socket which is welded to another piece of rebar;
as per claim 2, rebar locked into place by a spring-loaded dowel; and,
as per claim 2, spring-loaded dowel penetrates the inserting plug when the inserting plug pushes down a cap at the bottom of the receiving socket which had been holding the spring-loaded dowel in place.
